(19) United States
(12) Patent Application Publication
(10) Pub. No.: US 2024/0065307 A1
(43) Pub. Date: Feb. 29, 2024

(54) METHOD TO CHECK A COFFEE BEANS ROASTING SYSTEM

(71) Applicant: SOCIETE DES PRODUITS NESTLE S.A., Vevey (CH)

(72) Inventors: JOEL MOREND, Chatonnaye (CH); FLAVIEN FLORENT DUBIEF, Champagne (CH); MAXIME BAEKELANDT, Gent (BE)

(21) Appl. No.: 18/259,690

(22) PCT Filed: Dec. 6, 2021
(86) PCT No.: PCT/EP2021/084433

§ 371 Date: Jun. 28, 2023

(30) Foreign Application Priority Data
Dec. 31, 2020 (EP) 20217999.0

(51) Int. Cl. A23N 12/12; A23F 5/04; B01D 46/00; B01D 46/10; B01D 46/44; B01D 53/04; B03C 3/011; B03C 3/017; B03C 3/019

(52) U.S. Cl. CPC A23N 12/125; A23F 5/04; B01D 46/0043; B01D 46/0084; B01D 46/10; B01D 46/446; B01D 53/0407; B01D 53/0454; B03C 3/011; B03C 3/017; B03C 3/019; B01D 2253/102; B01D 2257/708; B01D 2273/30

(57) ABSTRACT

The invention concerns a method to check a roasting system (10), said system comprising: —at least one roasting apparatus (2), —at least one smoke treating unit (3), said smoke treating unit comprising at least one removable filtering device (221, 222, 223), —a smoke driver (23) configured to drive smoke from the roasting apparatus (2) to said at least one filtering device, wherein the at least one smoke treating unit (3) comprises at least one downstream pressure sensor (24), wherein the method comprises the steps of: —operating at least the smoke driver (23) to drive gas through the smoke filtering unit, —measuring the pressure P at the pressure sensor downstream the removable filtering device, —calculating the drop of pressure ΔP=P−Pref compared to a pressure of reference P_{ref}, —comparing said drop of pressure ΔP to a predetermined threshold ΔP₀ corresponding to the presence of said at least one removable filtering device upstream the pressure sensor, —if said drop of pressure ΔP is inferior to said predetermined threshold ΔP₀, then displaying an alarm.

### FIELD OF THE INVENTION

The present invention relates to relates to apparatuses for roasting coffee beans in a safe environment.

### BACKGROUND OF THE INVENTION

The roasting of coffee beans is a well-known process. The main steps consists in heating the beans to a desired roasting level and then cooling or quenching the heated beans to stop the roasting. During heating, smoke is emitted. This smoke contains safe and desired components all together, in particular the usual roasted coffee aroma, but also undesired less safe volatile organic compounds (VOC) VOC such as pyridine, 2-furane methanol, caffeine furfural, formaldehyde, acetaldehyde, . . . and particulate matter (PM_{2.5}, PM₁₀), . . . .

When roasting is implemented in manufacturing places producing important quantities of roasted beans, generally all the conditions for catching unsafe components are supplied.

But, there is a recent trend to implement small batch roasting with small roasters in shops, restaurants and coffees where customers are able to consume coffee brewed from freshly roasted beans. The roaster does not only provide freshness and theater advantages, but also dispenses the pleasant roasted coffee aroma inside the shop or coffee.

Yet, as mentioned above, harmful components are emitted too. When the roaster is used in a closed environment like a shop, coffee or restaurant, the emission of some components can become harmful depending on the size of the room, the ventilation of the room, . . . . For people working several hours in the room, smelling the smokes of the roaster can lead to a health problem.

As a result, in such an environment, it is recommended to stop the emission of smoke from the roaster to avoid any healthy issue for people present in the shop. The existing solutions consist in destroying contaminants, such as an afterburner enabling thermal oxidation of contaminants or a catalytic afterburner or retaining contaminants inside the apparatus like mechanical filters (metallic sieves or paper filter), an active carbon filter or an electrostatic precipitator or combination thereof.

When an active carbon filter is used, the active carbon substance, usually hold in a bag, must be regularly changed to be regenerated. During this operation, the old bag of active carbon is removed and a new fresh one is introduced. During this operation, it may happen that the operator removes the old bag but forgets to introduce the new one. This error can be emphasised by the fact that the smoke filter can comprise a combination of several different filters, all of them requiring a different cleaning treatment.

In the case of an active carbon filter, the absence of the active carbon bag inside the filter does not prevent the roasting operation, as the roasting emissions can freely flow through, and the operator may not realise that the smoke is not treated before several roasting operations are implemented, when malodorous smells will appear, which is not desired in a shop, coffee or restaurant.

### SUMMARY OF THE INVENTION

An object of the invention is to address the above existing problem or similar problems.

In particular, an object of the invention is to address the problem of informing the operator that a part of the smoke filter such as the active carbon bag is absent.

It would be advantageous to provide a method to enable the roasting operator to be informed of the absence of a part of the smoke filter without adding sensors specific to that part.

In a first aspect there is provided a method to check a roasting system, said system comprising:
at least one roasting apparatus, said apparatus producing smoke during the heating of coffee beans, and
at least one smoke treating unit configured to treat at least a part of the flow of smoke produced by the at least one roasting apparatus, said smoke treating unit comprising at least one removable filtering device,
a smoke driver configured to drive smoke from the roasting apparatus to said at least one filtering device,
wherein the at least one smoke treating unit comprises at least one downstream pressure sensor, said downstream pressure sensor being configured to measure the pressure downstream said at least one removable filtering device,
wherein the method comprises the steps of:
   operating at least the smoke driver to drive gas through the smoke filtering unit,
   measuring the pressure P at the pressure sensor downstream the removable filtering device,
   calculating the drop of pressure ΔP=P−P_{ref} compared to a pressure of reference P_{ref},
   comparing said drop of pressure ΔP to a predetermined threshold ΔP₀ corresponding to the presence of said at least one removable filtering device upstream the pressure sensor,
   if said drop of pressure ΔP deviates from said predetermined threshold ΔP₀, then displaying an alarm.

The objective of the method is to check if a roasting system is working properly and in particular to check that the smoke treating unit of the system is working properly, precisely to check that no removable filtering device of the smoke treating unit is missing.

This roasting system, in which the method is applied, comprises two types of apparatuses:
first, the roasting apparatus in which beans are heated to be roasted, and
secondly, the smoke treating unit configured to treat the smoke generated inside the first roasting apparatus during the roasting of the coffee beans.

The two apparatuses can be sub-parts of one single main system or alternatively, the two apparatuses can be conceived as separated modules cooperating together during the process of roasting.

As described below, the system can comprise several roasting apparatuses and/or several smoke treating units.

Any type of roasting apparatus can be used. In the roasting apparatus, coffee beans are heated and preferably mixed to homogenise heating through the beans.

The source of heating can be a burner (meaning combustion) fed by natural gas, liquefied petroleum gas (LPG) or even wood. Alternatively the heat source can be an electrical resistor, a ceramic heater, a halogen source, a source of infrared or of microwaves.

Preferably the source of heating is electrically powered so that the air contaminants produced during the roasting are contaminants generated from the heating of coffee beans themselves only and not from the burning of gases as it happens when the source of heating is a gas burner using natural gas, propane, liquefied petroleum gas (LPG) or even wood.

The mixing of the beans during the roasting operation can be obtained with a fluidic bed of hot air or mechanically with stirring blades or a rotating drum.

Preferably the roasting apparatus is hot air fluid bed chamber. Within such a chamber, heated air is forced through a screen or a perforated plate under the coffee beans with sufficient force to lift the beans. Heat is transferred to the beans as they tumble and circulate within this fluidized bed.

Alternatively the roasting apparatus can be a drum chamber wherein the coffee beans are tumbled in a heated environment. The drum chamber can consist of a drum rotating along a horizontal axis or the drum chamber can comprise stirring blades to tumble the coffee beans in a heated environment.

The roasting apparatus comprises an outlet from which smoke produced during the roasting operation can be evacuated.

In one embodiment, the system can comprise several roasting apparatuses, the outlets of these different roasting apparatuses being configured to be mixed together before being treated by one or several smoke treating units.

Generally, the smoke treating unit of the system comprises a smoke inlet configured to cooperate with this smoke outlet of the roasting apparatus and to collect smoke through this smoke inlet.

The smoke treating unit treats the smoke in order to reduce or eliminate harmful contaminants the smoke contains. The smoke treating unit comprises at least one filtering device configured to destroy or trap contaminants. This unit can comprise:
at least one active treating filter that destroys contaminants inside the apparatus, such as an afterburner enabling thermal oxidation of contaminants or a catalytic afterburner, or
at least one passive treating filter that retains contaminants inside the apparatus like mechanical filters (metallic sieves, a high efficiency particulate accumulator (HEPA) or paper filter), an active carbon filter or other adsorbent filter, or an electrostatic precipitator, or a combination of the above units.

Usually, the smoke treating unit comprises at least one removable filtering that is cleanable, disposable or able the be regenerated, preferably comprised in the list of: a metallic sieve, an electrostatic precipitator, a HEPA filter, a paper filter, cotton, cloth, an adsorbent material filter and combinations thereof.

These types of filtering devices are removable from the smoke treating unit to be cleaned or disposed and replaced by new filters. It is particularly the case for the passive treating filters:
metallic sieves and plates of electrostatic precipitators are removed to be washed and then re-installed inside the smoke treating unit,
HEPA, paper, cotton, cloth filters are removed to be disposed and new papers are installed inside the smoke treating unit,
bags of adsorbent materials are removed from the active carbon filter to be regenerated and new bags are installed inside the smoke treating unit.

When the smoke treating unit comprises several filtering devices, they are usually positioned in series along the direction of the flow of smoke. Usually, devices for filtering particulate matters (PMs) are positioned upstream the devices for filtering volatile organic compounds (VOCs).

In one preferred embodiment the smoke treating unit can comprise at least one adsorbent filter, preferably an active carbon. This type of filter adsorbs VOCs. This filter requires specific operating conditions in terms of temperature and for this reason a temperature sensor is frequently positioned close to this filtering device.

The active carbon filter comprises a removable active carbon bag. This bag contains the active carbon that adsorbs VOCs and this bag must be removed when the active carbon has reached its maximal adsorption capacity and replaced by a fresh active carbon holder. Usually the bag is made of a material that enables the smoke to flow through but retains the active carbon that is usually under the form of granules. The removable bag is positioned inside a dedicated area of the smoke filtering unit.

The smoke is driven inside the smoke treating unit and the filtering devices by means of a smoke driver configured to circulate smoke through the smoke treating unit from the smoke inlet or collecting device to an outlet of the smoke treating unit. At the outlet, the smoke can be safely released inside the atmosphere of a room since the contaminants have been trapped.

The smoke driver is usually a fan driving the smoke to the outlet.

Generally the smoke driver is part of the smoke treating unit. Preferably it is a fan positioned next to the outlet of the smoke treating unit. As a result, the fan is not contaminated by the non-treated smoke and its maintenance is easier.

Alternatively, the smoke driver can be positioned outside the smoke treating unit; then the driver and the unit are connected through ducts. In particular, this embodiment can be implemented if the roasting system comprises several smoke treating units and one common smoke driver to drive gas through all the smoke treating units.

Alternatively, the smoke driver can be the fan of the roasting apparatus that pushes the smoke in direction the smoke treating unit.

The smoke treating unit comprises at least one downstream pressure sensor, said downstream pressure sensor being configured to measure the pressure downstream removable filtering device of the smoke treating unit.

The terms “downstream” and “upstream” are understood according to the flow of smoke through the smoke treating unit and the filtering device.

The pressure sensor can be any sensor configured to measure static pressure. This sensor can be configured for the measure of pressure only or this sensor can be a multi-sensor component able to measure various other parameters than pressure like humidity, temperature, VOCs content. Examples of such sensors are air or gas sensors.

In order to check the roasting system and in particular the presence (by default the absence) of a removable filtering device, the method comprises the steps of:
operating at least the smoke driver to drive gas through the smoke filtering unit,
measuring the pressure P at the pressure sensor downstream the removable filtering device,
calculating the drop of pressure ΔP=P−P_{ref} compared to a pressure of reference P_{ref},
comparing said drop of pressure ΔP to a predetermined threshold ΔP₀ corresponding to the presence of the removable filtering device upstream the pressure sensor,
if said drop of pressure ΔP deviates from said predetermined threshold ΔP₀, then displaying an alarm.

It has been observed that, when all the filtering devices of the smoke treating unit are present inside said unit, the smoke driver must apply a strong suction force, if it is positioned downstream the filtering devices (or pushing force, if it is positioned upstream the filtering devices) to get the circulation of the gas through all the filtering devices and out of the smoke treating unit. This strong suction force creates a pressure drop inside the smoke treating unit compared to the situation where the smoke driver is not working. But if at least one of the filtering devices is missing inside the smoke treating unit, the movement of the gas is relatively easier (depending on the nature of the missing filtering device) and the pressure drop inside the smoke treating unit is lower compared to the high pressure drop measured with the smoke treating unit comprising all the filtering devices.

Consequently, by measuring the pressure inside the smoke treating unit, if it is noticed that the drop of pressure ΔP deviates from a predetermined threshold ΔP₀, corresponding to the presence of all the filtering devices inside the smoke treating unit, then the risk at least one of the removable filtering devices is not present is high and then an alarm can be displayed to request the operator to check the presence of the filtering devices inside the smoke treating unit.

Consequently, the present method enables the detection of a missing removable filtering device inside the smoke treating unit and can alert the operator.

The step of operating the roasting apparatus in order to drive gas can be a coffee beans roasting operation, an operation of pre-warming of the roasting apparatus or an operation of initialization of the filtering device.

Whatever the operation, gas is driven by operating the smoke driver of the smoke treating unit. That can happen during an operation of pre-warming of the roasting system or an operation of initialization of the filtering device when this filtering device is introduced for the first time in the smoke treating unit, for example after a maintenance or replacement operation. Then, gas can be air simply.

Usually, when the method is applied while operating a coffee beans roasting operation, this roasting operation is the first operation after a maintenance operation of the smoke treating unit, preferably maintenance of the at least one filtering device. Then, the gas is smoke.

Indeed, from the first operation implemented after a cleaning or maintenance operation of the smoke treating unit, it is important to know that at least one of the filtering devices is absent. The operator can be immediately informed of the absence of a part of the filtering device and can be prevented from launching a new roasting operation without having checked, and if necessary re-installed, the filtering device inside the smoke filtering unit.

Usually, the method is all the more efficient if the pressure P is measured when the smoke driver is in a stable status of operation. If the method to check is implemented in the roasting system at rest, then it is preferred to wait for the stable speed of the smoke driver before the pressure P is measured. For a smoke driver that is a fan, a period of time of 20 or 30 seconds is usually sufficient to reach a stable speed, which means that the pressure can be measured very rapidly and the presence of the filtering device can be immediately detected.

The drop of pressure ΔP corresponds to the difference of the pressure measured at the pressure sensor with a pressure of reference P_{ref}, that is P−P_{ref}.

This pressure of reference P_{ref} can be the ambient pressure P_{amb}. Ambient pressure can be measured with the pressure sensor while the roasting system is at rest and the smoke driver is not operating.

Alternatively, this pressure of reference P_{ref} can be a predetermined fixed pressure. This predetermined fixed pressure can be pre-set based one the configuration of the smoke treating unit such as the nature of its filtering device(s), the design of this unit and/or the nature or the power of the smoke driver.

The drop of pressure ΔP is compared to a predetermined threshold ΔP₀ corresponding to the presence of said at least one removable filtering device upstream the pressure sensor.

Usually, in the method, the pre-determined threshold ΔP₀ is set according to the nature of the at least one removable filtering device positioned upstream the pressure sensor.

As mentioned above, filtering devices can be of various natures in terms of design and materials (simple and thin metallic sieve, large bag of material adsorbent, metallic electrode plates of electrostatic precipitator, . . . ) with the effect of retaining the flow of gas differently. Accordingly, to determine if the filtering device(s) designed for the smoke filtering device is/are present upstream the pressure sensor, the method is applied in reference to the pre-determined threshold ΔP₀ corresponding to that filtering device(s).

The threshold ΔP₀ can be predetermined by experimentations during operations of driving gas inside the smoke treating unit. Machine learning can also be applied based on these experimentations or further to the successive implementations of the method.

If the smoke treating unit comprises one filtering device only, then the comparison with one predetermined threshold ΔP₀ is sufficient.

If the smoke treating unit comprises several filtering devices, then, in the simplest embodiment, the drop of pressure ΔP can be compared to one single predetermined threshold ΔP₀ corresponding to the presence of all the filtering devices inside the smoke treating unit. If the drop of pressure ΔP deviates from said predetermined threshold ΔP₀, then an alarm is displayed to urge the operator to open the smoke treating unit and check visually if one of the filtering devices is missing.

In a more advanced embodiment, if the smoke treating unit comprises several filtering devices, then, the drop of pressure ΔP can be compared to several predetermined thresholds ΔP₀ᵢ, each of said predetermined threshold ΔP₀ᵢ corresponding respectively to the absence of one of the filtering devices or the absence of a combination of several filtering devices. If the drop of pressure ΔP deviates from the global predetermined threshold ΔP₀, then the drop of ΔP can be compared to the predetermined thresholds ΔP₀ᵢ, to identify the absent filtering device or the absent combination of filtering devices.

A predetermined thresholds ΔP₀ᵢ to identify an absent combination of filtering devices can be used when several filtering devices must be removed simultaneously from the smoke treating unit during a maintenance operation. It can be the case for several filters attached to a common support for example.

In that latter embodiment, an alarm can displayed to urge the operator to open the smoke treating unit and check visually if one particular filtering device is missing.

In one particular embodiment, the smoke treating unit can comprise at least one upstream pressure sensor, said pressure sensor being configured to measure the pressure of the flow of smoke upstream said at least one removable filtering device, and then the pressure of reference P_{ref} can be the pressure measured at said upstream pressure sensor.

This embodiment enables the comparison of the measured pressure P to a pressure of reference even if the conditions to drive gas through the smoke filtering unit varies. In particular, if the checking method is implemented at the beginning of a roasting operation, the speed of the smoke driver and, as a result, the flow of gas can be adjusted based on variables that are the type of roasted coffee beans and/or the level of roasting desired for the coffee beans. By using a pressure of reference measured in a gas flow that is the same as the gas flow on which the pressure is measured, the calculated drop of pressure is more accurate.

In one embodiment, the drop of pressure ΔP can be compared to the predetermined threshold ΔP₀ by calculating the difference between ΔP and ΔP₀, and then the deviation of the drop of pressure ΔP can be deduced by comparing said difference to a pre-defined maximal difference.

The maximal difference can be pre-defined in order to take into account error in the measure of pressure and small fluctuations in the flow of gas, in particular by statistical data analysis during tests with the roasting system.

In another embodiment the drop of pressure ΔP can be compared to the predetermined threshold ΔP₀ by calculating the ratio

$$\frac{Δ P}{Δ {P}_{0}} ,$$

and then the deviation of the drop of pressure ΔP can be deduced by comparing said ratio to 1, preferably to a pre-defined maximal value, said value being inferior to 1.

The maximal value can be pre-defined in order to take into account error in the measure of pressure and small fluctuations in the flow of gas.

In one embodiment, the method can be applied in a system that comprises
several smoke treating units, each of said smoke treating units being configured to conduct and treat at least a part of the smoke through a dedicated path, and
an inlet ducting device to guide smoke emitted by the at least one roasting apparatus to at least one of the smoke treating units,
an outlet ducting device to guide smoke treated by the smoke treating units to an outlet of the system,
and the at least one downstream pressure sensor can be positioned to measure the pressure at said outlet ducting device.

In a second aspect, there is provided a system for roasting coffee beans, said system comprising:
at least one roasting apparatus, said apparatus producing smoke during the heating of coffee beans, and
at least one smoke treating unit configured to treat at least a part of the flow of smoke produced by the at least one roasting apparatus, said smoke treating unit comprising at least one removable filtering device,
a smoke driver configured to drive smoke from the roasting apparatus to said at least one filtering device,
wherein the at least one smoke treating unit comprises at least one downstream pressure sensor, said downstream pressure sensor being configured to measure the pressure downstream said at least one removable filtering device,
a control system operable operable to perform the method such as described above.

Preferably, the roasting apparatus can comprise a display unit in order to display the alarm which can be visual and/or a sound.

Preferably, the smoke treating unit comprises at least one adsorbent material filter such as an active carbon filter.

Preferably, the smoke treating unit can comprise at least one other filtering device than the adsorbent material filter. This other filtering device can be comprised in the list of: a high efficiency particulate accumulator filter, a metallic filter, an electrostatic precipitator, paper filter, cotton, cloth. Optionally, the smoke treating unit can comprise additional filtering devices like wet-scrubbers, catalytic converters, afterburners.

Preferably, the smoke filtering sub-unit comprises successively, according to the direction of the flow of the smoke inside the smoke treating unit, at least one filter to remove particulate matters and then an electrostatic precipitator and then the active carbon filter. This order prevents the active carbon filter from being clogged by particulate matters.

The smoke driver is generally a fan driving the smoke to the outlet.

Preferably the fan is positioned next to the outlet of the smoke treating unit. As a result, the fan is not contaminated by the non-treated smoke and its maintenance is easier.

According to one preferred embodiment, the smoke filtering sub-unit comprises at least successively:
a metallic mesh, then
an electrostatic precipitator, and then
the active carbon filter according to the movement of the flow of the smoke inside the smoke treating unit.

Preferably within this embodiment, the active carbon filter is positioned physically above the electrostatic precipitator. Accordingly, the smoke is introduced upwardly through the successive devices.

Depending on the integration of the roasting apparatus and the smoke treating unit, the control system can be shared between both apparatuses and the steps of the method can be shared between the processing units of at least these two apparatuses.

In one embodiment, the method can be executed by the processing unit of the roasting apparatus and by the processing unit of the smoke treating unit, both processing units communicating together. In particular:
the processing unit of the smoke treating unit can implement the steps of:
   operating the smoke driver in order to drive gas,
   measuring the pressure,
   calculating the drop of pressure,
   if necessary ordering the display of an alarm to the roasting apparatus,
the processing unit of the roasting apparatus can implement the steps of:
   if required operating the roasting apparatus in order to produce hot gas,
   displaying the cleaning alarm.

In another embodiment,
the processing unit of the smoke treating unit can implement the steps of:
   operating the smoke driver in order to drive gas,
   measuring the pressure,
   communicating the value of the measured pressure to the roasting apparatus, and
the processing unit of the roasting apparatus can implement the steps of:
   if required operating the roasting apparatus in order to produce hot gas,
   calculating the drop of pressure based on the communicated pressure,
   if necessary displaying the cleaning alarm.

In another embodiment, the processing unit of the smoke treating unit can implement all the steps, particularly if the checking method is not implemented during a roasting operation.

Preferably, the roasting apparatus can comprise a display unit in order to display the alarm.

Alternatively, the smoke treating unit can comprise a device to display the alarm such as a lighting button and/or a sound and/or a voice message.

In another alternative, the control system can be configured to display the alarm on a mobile device in communication with the system.

In a third aspect, there is provided a computer program comprising instructions to cause the above system according to the second aspect to perform the method such as described above in the first aspect.

In one embodiment, the computer program can be executed by the processing unit of the roasting apparatus and by the processing unit of the smoke treating unit, both processing units communicating together. In particular:
the processing unit of the smoke treating unit can implement the steps of:
   operating the smoke driver in order to drive gas,
   measuring the pressure,
   calculating the drop of pressure,
   if necessary ordering the display of an alarm to the roasting apparatus,
the processing unit of the roasting apparatus can implement the steps of:
   if required operating the roasting apparatus in order to produce hot gas,
   displaying the cleaning alarm.

In another embodiment,
the processing unit of the smoke treating unit can implement the steps of:
   operating the smoke driver in order to drive gas,
   measuring the pressure based on the communicated pressure,
   communicating the value of the measured pressure to the roasting apparatus, and
the processing unit of the roasting apparatus can implement the steps of:
   if required operating the roasting apparatus in order to produce hot gas,
   calculating the drop of pressure,
   if necessary displaying the cleaning alarm.

In another embodiment, the processing unit of the smoke treating unit can implement all the steps, particularly if the checking method is not implemented during a roasting operation.

In a fourth aspect, there is provided a computer readable storage medium having stored thereon the computer program such as described above.

In the present application, the term “several” means at least two.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1 is a view of a system according to the present invention illustrating the path of the smoke through the system,

FIG. 2 illustrates the active carbon filter of the smoke treating unit of FIG. 1,

FIG. 3 shows a block diagram of a control system of the system according to FIGS. 1 and 2,

FIG. 4 illustrates the drop of pressure inside the smoke treating unit of FIG. 1 with the active carbon holder present or not,

FIG. 5 illustrates an alternative system to the one illustrated in FIG. 1,

FIG. 6 illustrates a system with several smoke treating units according to the invention.

### DETAILED DESCRIPTION OF EXEMPLARY EMBODIMENTS

System for Roasting

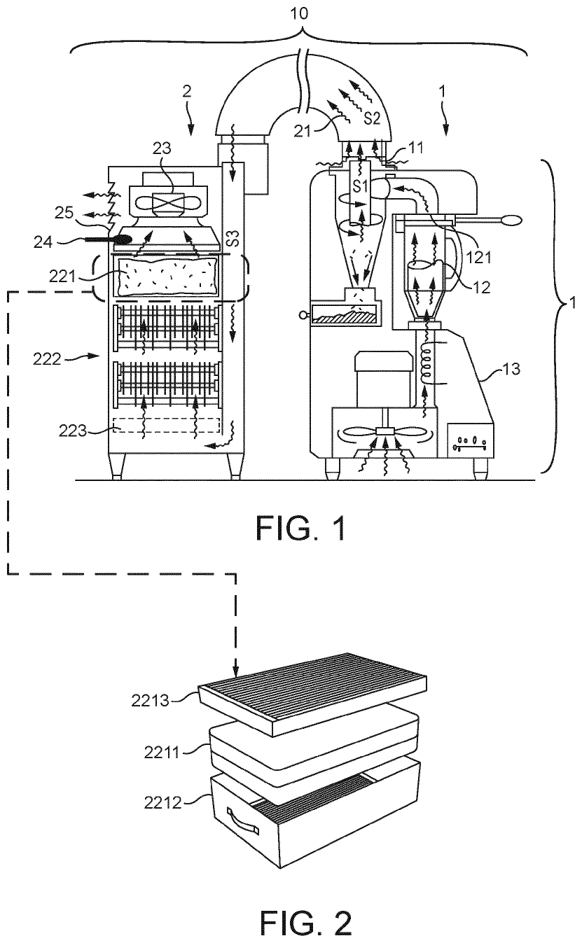

FIG. 1 shows an illustrative view of a system of a roasting apparatus 1 and a smoke treating unit 2. Functionally, the roasting apparatus is operable to roast coffee beans and the smoke treating unit is operable to treat the smoke generated during roasting by the roasting apparatus.

Roasting Apparatus

The roasting apparatus 1 is operable to receive and roast coffee beans inside a roasting chamber 12.

Preferably, the roasting apparatus 1 comprises a roasting chamber 12 in which a flow of hot air is introduced to agitate and heat the beans. The hot air flow is usually produced by an air flow driver and a heater. These devices are positioned below the roasting chamber and introduce the flow of hot air through the bottom of the chamber. In the illustrated figure, the bottom of the chamber is configured to enable air to pass through, specifically it can be a perforated plate on which the beans can lie and through which air can flow upwardly.

The air flow driver is operable to generate a flow of air upwardly in direction of the bottom of the vessel. The generated flow is configured to heat the beans and to agitate and lift the beans. As a result, the beans are homogenously heated. Specifically, the air flow driver can be a fan powered by a motor. Air inlets can be provided inside the base of the housing in order to feed air inside the housing, the air flow driver blowing this air in direction of the chamber 12.

The heater is operable to heat the flow of air generated by the air flow driver. Preferably, the heater is an electrical resistance positioned between the fan and the perforated plate with the result that the flow of air is heated before it enters the chamber 12 to heat and to lift the beans.

The heater and/or the fan are operable to apply a roasting profile to the beans, this roasting profile being defined as a curve of temperature against time.

Preferably, the roasting apparatus comprises a user interface 13 enabling:
the input of information about the roasting, in particular the quantity of beans introduced inside the roasting chamber and the desired level of roasting, and the output of information about the roasting operation (status, temperature, time) and
preferably about the output of information about the smoke treating unit 2 in particular about the cleaning of the electrostatic precipitator 222.

The roasting of the beans generates a smoke that is driven to the top opening 121 of the roasting chamber due to the flow of air generated by the air flow driver and as illustrated by arrow S1 in FIG. 1.

Generally a chaff collector is in flow communication with the top opening 121 of the chamber to receive chaffs that have progressively separated from the beans during roasting and due to their light density are blown off to the chaff collector.

The rest of the smoke is evacuated through the smoke outlet 11 at the top of the roasting apparatus.

Smoke Treating Unit

The smoke treating unit 2 is operable to receive and treat the smoke S1 emitted at the smoke outlet 11 of the roasting apparatus.

First, the smoke treating unit 2 comprises a smoke inlet or collecting device 21 adapted to collect the smoke. This smoke collecting device 21 or collecting device forms an internal void space or duct guiding the smoke (dotted lines S1, S2, S3) from the outlet 11 of the roasting apparatus in direction of the filtering devices of the smoke filtering sub-unit 22.

The smoke filtering sub-unit 22 comprises an active carbon filter 221 adapted to remove VOCs from the smoke.

FIG. 2 illustrates the main components of this active carbon filter 221. The filter comprises a box 2212 configured to hold the adsorbent material, that is preferably active carbon. Since this adsorbent is usually in the form of granules, the adsorbent is hold in a holder 2211 of which wall enables smoke to pass through freely. Usually this holder is a bag of plastic mesh. The top and bottom walls of the box are simple grids enabling the smoke to pass through freely while retaining the holder inside the box. The box 221 is removeable from the smoke filtering unit for maintenance. A handle on one side wall enables the operator to withdraw the box. Once removed from the unit, the cover 2213 can be removed to get access to the active carbon holder 2211.

The maintenance operation of the active carbon filter consists in replacing the holder 2211 by a new one. When the adsorbent material has reached its maximum capacity of adsorption, the material must be removed to be regenerated. Regeneration cannot be realised on-site.

Consequently, the old holder is replaced by a fresh one.

During this maintenance operation, the operator can forget to re-introduce a new holder inside the box before repositioning the box in the unit.

In the particularly illustrated embodiment, the smoke filtering sub-unit 22 can comprise
a device 223 adapted for filtering large particulate matter like PM10, for example a metallic mesh and an associated diffuser, generally a metallic grid positioned in front (that is upstream) of the mesh.
an electrostatic precipitator 222 adapted for filtering small particulate matter.

Preferably, the device for removing particulate matter are positioned upstream the active carbon filter. This upstream position guarantees that particulate matter do not foul the active carbon filter.

Physically, the electrostatic precipitator is positioned below the active carbon filter to avoid that particulates fall from the electrostatic precipitator on the active carbon filter when the electrostatic precipitator is switched off.

The smoke filtering sub-unit 22 comprises a smoke driver 23, generally a fan, for sucking the contaminated smoke from the inlet 211 of the collecting device through the smoke filtering sub-unit 22, where it is treated, to the outlet 25 of the smoke filtering sub-unit 22, where it is dispensed in ambient atmosphere safely.

The smoke filtering sub-unit 22 comprises a pressure sensor 24 positioned just downstream the active carbon filter and configured to measure the static pressure. In particular, the sensor 24 is a multi-component gas sensor able to measure pressure, temperature and VOCs composition of a gas. It is usually used to analyse the properties of the gas dispensed out of the smoke treating unit, in particular when the gas is dispensed in a public room. This type of sensor 24 is usually used to control that the temperature of the smoke passing through the active carbon filter 221 is not too high.

This existing sensor can be used too to apply the method of the present invention as described below.

Control System of the System of the Roasting Apparatus and the Smoke Treating Unit

With reference to FIGS. 1, 2 and 3, the control system 3 will now be considered: the control system 3 is operable to control the smoke filtering unit 2.

Depending on the level of integration of the roasting apparatus 1 and the smoke filtering unit 2, the control system can be shared between the processing units of these two apparatuses:
if the smoke treating unit 2 is part of the roasting apparatus 1, usually the processing unit of the roasting apparatus is the master and the processing unit of the filter is the slave.
if the roasting apparatus 1 and the smoke treating unit 2 form two different apparatuses, each of them with its own processing unit, then these processing units can be configured to communicate to implement the method.

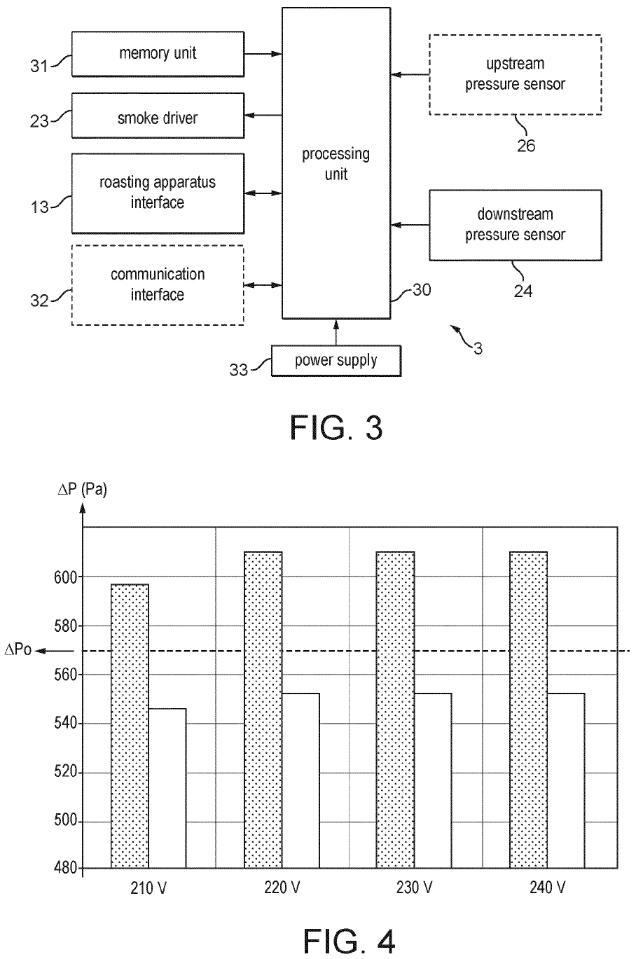

FIG. 3 illustrates the control system of the smoke filtering unit 2 of FIG. 1.

The control system 3 typically comprises at a second level of smoke filtering unit 2: a processing unit 30, a power supply 33, a memory unit 31, optionally a communication interface 32 for remote connection.

The processing unit 30 is configured to output feedback to the user interface 13 of the roasting apparatus in particular to display an alarm related to the detection of the absence of active carbon filter holder inside the active carbon filter. In an alternative configuration, the some treating unit 2 can comprise its own user interface to display this information, for example lighting buttons that can be lighted according to the presence or not of the holder.

The processing unit 30 may also display information to the user interface 13 about:
cleaning instructions,
reset of the alarm status
warnings,
error alarms.

The hardware of the user interface may comprise any suitable device(s), for example, the hardware comprises one or more of the following: buttons, such as a joystick button, knob or press button, joystick, LEDs, graphic or character LDCs, graphical screen with touch sensing and/or screen edge buttons. The user interface 20 can be formed as one unit or a plurality of discrete units.

A part of the user interface can also be on a mobile app when the apparatus is provided with a communication interface 32 as described below. In that case at least a part of input and output can be transmitted to the mobile device through the communication interface 32.

The processing unit 30 generally comprises memory, input and output system components arranged as an integrated circuit, typically as a microprocessor or a microcontroller. The processing unit 30 may comprise other suitable integrated circuits, such as: an ASIC, a programmable logic device such as a PAL, CPLD, FPGA, PSoC, a system on a chip (SoC), an analogue integrated circuit, such as a controller. For such devices, where appropriate, the aforementioned program code can be considered programmed logic or to additionally comprise programmed logic. The processing unit 30 may also comprise one or more of the aforementioned integrated circuits. An example of the later is several integrated circuits arranged in communication with each other in a modular fashion e.g.: a slave integrated circuit to control the smoke treating unit 2 in communication with a master integrated circuit to control the roasting apparatus 10, a slave integrated circuit to control the user interface 13 in communication with a master integrated circuit to control the roasting apparatus 10

The control system 30 can comprise a communication interface 32 for data communication of the system 10 with another device and/or system, such as a server system, a mobile device. The communication interface 32 can be used to supply and/or receive information related to the coffee beans roasting process, such as roasting process information, type of the beans. The system can also receive information about the characteristics of the removable filtering devices 221 part of the smoke treating unit and in particular the characteristics of the refillable parts of these filtering devices such as the active carbon bag 2211. Depending on the embodiment of the invention, pre-determined threshold ΔP₀ or R₀ related to the use of specific removable filtering devices 221 can be downloaded remotely. Alternatively, such information can be inputted manually by the operator through the user interface. The communication interface 32 may comprise first and second communication interface for data communication with several devices at once or communication via different media.

The communication interface 32 can be configured for cabled media or wireless media or a combination thereof, e.g.: a wired connection, such as RS-232, USB, I2C, Ethernet define by IEEE 802.3, a wireless connection, such as wireless LAN (e.g. IEEE 802.11) or near field communication (NFC) or a cellular system such as GPRS or GSM. The communication interface 32 interfaces with the processing unit 30, by means of a communication interface signal. Generally the communication interface comprises a separate processing unit (examples of which are provided above) to control communication hardware (e.g. an antenna) to interface with the master processing unit 30. However, less complex configurations can be used e.g. a simple wired connection for serial communication directly with the processing unit 30.

The power supply 33 is operable to supply electrical energy to the said controlled components and the processing unit 30. The power 33 may comprise various means, such as a battery or a unit to receive and condition a main electrical supply.

The processing unit 30 generally comprises a memory unit 31 for storage of instructions as program code and optionally data. To this end the memory unit typically comprises: a non-volatile memory e.g. EPROM, EEPROM or Flash for the storage of program code and operating parameters as instructions, volatile memory (RAM) for temporary data storage. The memory unit may comprise separate and/or integrated (e.g. on a die of the semiconductor) memory. For programmable logic devices the instructions can be stored as programmed logic.

The instructions stored on the memory unit 31 can be idealised as comprising a program to check the presence of the active carbon filter in the smoke treating unit of the system and the display of an alarm.

The processing unit 30 is configured to output the value of the pressure P measured by the pressure sensor 24, and optionally the other pressure sensor 26 if present.

During the operation of checking, the control system 3 is operable:
to operate the smoke driver 23 to drive gas through the smoke filtering unit 2,
to measure the pressure P at the pressure sensor 24 downstream the active carbon filter,
to calculate the drop of pressure ΔP compared to the pressure of reference P_{Ref}, that is ΔP=P−P_{ref},
to compare said drop of pressure ΔP to a predetermined threshold ΔP₀ corresponding to the presence of the active carbon filter upstream the pressure sensor,
to display an alarm, if said drop of pressure ΔP deviates from said predetermined threshold ΔP₀.

FIG. 4 illustrates the drop of pressure ΔP calculated for the smoke treating unit 3 while said unit comprises the active carbon holder 2211 (grey bar) or while said unit does not comprise the active carbon holder 2211 (white bar).

The drop of pressure was calculated from the pressure measured at the sensor 24 and by reference to the ambient pressure, which was measured while the smoke driver was at rest.

The drop of pressure was calculated in different operating conditions of the smoke treating unit, these operating conditions consisting in modifying the voltage applied to the motor of the fan 23 in order to modify the flow of gas inside the smoke treating unit 2. As illustrated, four different voltages were applied at 210 V, 220 V, 230 V and 240 V. These different voltages can correspond to the production of different flows for different roasting operations or for different parts of the same roasting operation.

It can be observed that, whatever the flow of gas inside the smoke treating unit, the drop of pressure when the active carbon holder 2211 is absent (white bar) is far inferior to the drop of pressure when the active carbon holder 2211 is present (grey bar). By setting the predetermined threshold ΔP₀ corresponding to the presence of the active carbon filter at a value of about 570 Pa, it is possible to discriminate the situations where the active carbon holder 2211 is present from the situations where this active carbon holder 2211 is absent whatever the flow rate.

In the practical and simplest mode illustrated in FIG. 4, the control system 3 was operable:
to calculate the drop of pressure ΔP, and
to compare said drop of pressure to ΔP₀.

In a variant, the control system 3 can be operable:
to calculate the drop of pressure ΔP, and
to compare the ratio of

$$\frac{Δ P}{Δ {P}_{0}}$$

to 1 or to a pre-defined maximal value R₀, said value being inferior to 1.

The comparison of the difference of drops of pressure ΔP and ΔP₀ can take into account a certain margin of error due to measure errors (position of the sensors, sensitivity of sensors).

As mentioned above, this pre-determined threshold ΔP₀, and eventually the pre-defined maximal value R₀, can be stored in the memory 31 of the control system.

The values can be made adjustable in the settings of the roasting system. The adjustment can be due to a change in the nature of the carbon filter (e.g. due to a change in procurement of the adsorbent material), a too high or low sensitivity in the display of the alarm, an improvement of the pre-determination of the parameters (ΔP₀, R₀, P_{ref}) further to a high number of experimentations in particular by machine learning.

Whatever the mode, in general the alarm urges the operator to check the presence of the active carbon filter before any new roasting operation is implemented.

Although illustrated with an active carbon filter, this method can be implemented with other filtering devices in a similar manner.

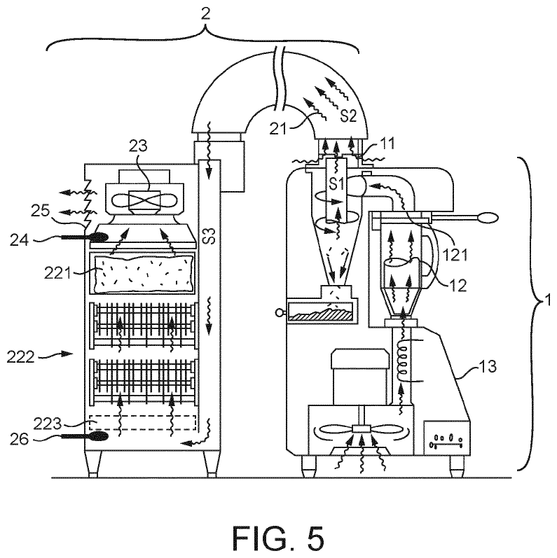

FIG. 5 illustrates a system similar to the one illustrated in FIG. 1 except that a second pressure sensor 26 is positioned upstream the PM filter 223.

In that system, during the operation of checking, the control system 3 is operable:
to operate the smoke driver 23 to drive gas through the smoke filtering unit 2,
to measure:
   the pressure P at the pressure sensor 24 downstream the active carbon filter, and
   the internal pressure P′ at the pressure sensor 26 upstream the active carbon filter, and
to calculate the drop of pressure ΔP compared to said internal pressure P′ used as the pressure of reference P_{Ref}, that is ΔP=P−P′,
to compare said drop of pressure ΔP to a predetermined threshold ΔP₀ corresponding to the presence of the active carbon filter upstream the pressure sensor,
to display an alarm, if said drop of pressure ΔP deviates from said predetermined threshold ΔP₀.

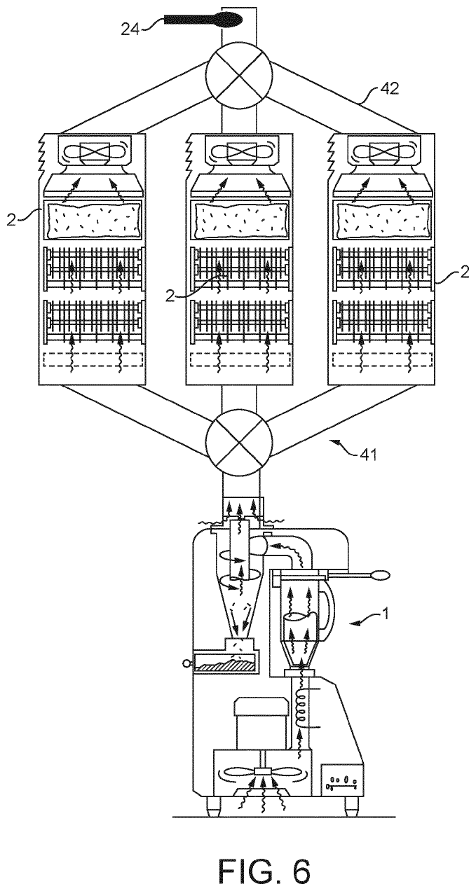

FIG. 6 illustrates a system comprising several smoke treating units 3. Such a configuration can be adapted to the treatment of an important volume of smoke, or to enable the maintenance of one smoke treating unit while the two others are operating. The smoke outlets of the roasting apparatuses are connected to an inlet ducting device 41 configured to guide smoke to at least one of the smoke treating units 3. An outlet ducting device 42 is configured to guide smoke treated by the smoke treating units 3 to an outlet of the system. Depending on the volume of emitted smoke, smoke can be sent to one, two or three of the smoke treating units. The pressure sensor 24 is positioned at outlet ducting device 42 and enables the detection of a missing filtering device in at least one of the smoke treating units 3 in a similar manner as in FIG. 1.

Different predetermined thresholds ΔP₀₁, ΔP₀₂, ΔP₀₃ can be pre-determined depending is one, two or the three smoke treating units are being operated.

One advantage of the method is that it can be implemented with pressure sensors that are not specifically dedicated to the implementation of that method. Pressure sensors positioned inside the smoke treating unit for other process controls can be used additionally to provide information about the presence of an essential part of the smoke treating unit after a maintenance operation. An error in re-installation can be detected with existing temperature sensors rather than adding sensors specifically dedicated to the detection of the presence of a filtering device such as a sensor establishing contact with the filter (such as a switch contact), an optical sensor, a sensor able to read the field of a magnetic element of the filter, an RFID device able to read an RFID tag of the filter.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

roasting apparatus 1
   smoke outlet 11
   roasting chamber 12
      top outlet 121
   user interface 13
smoke treating unit 2
   smoke collecting device 21
   smoke filtering sub-unit 22
      active carbon filter 221
      active carbon holder 2211
      box 2212
      cover 2213
      electrostatic precipitator 222
      PM filter 223
   smoke driver 23
   outlet 25
   pressure sensors 24, 26
control system 3
processing unit 30
memory unit 31
communication interface 32
power supply 33
inlet ducting device 41
outlet ducting device 42
system 10

1. A method to check a roasting system, said system comprising:
at least one roasting apparatus, said apparatus producing smoke during the heating of coffee beans, and
at least one smoke treating unit configured to treat at least a part of the flow of smoke produced by the at least one roasting apparatus, said smoke treating unit comprising at least one removable filtering device,
a smoke driver configured to drive smoke from the roasting apparatus to said at least one filtering device,
the at least one smoke treating unit comprises at least one downstream pressure sensor, said downstream pressure sensor being configured to measure the pressure downstream said at least one removable filtering device,
wherein the method comprises the steps of:
operating at least the smoke driver to drive gas through the smoke filtering unit,
measuring the pressure P at the pressure sensor downstream the removable filtering device,
calculating the drop of pressure ΔP=P−Pref compared to a pressure of reference Pref,
comparing said drop of pressure ΔP to a predetermined threshold ΔP0 corresponding to the presence of said at least one removable filtering device upstream the pressure sensor, and
if said drop of pressure ΔP is inferior to said predetermined threshold ΔP0, then displaying an alarm.

2. Method according to claim 1, wherein the step of operating the roasting apparatus in order to drive gas is a coffee beans roasting operation, an operation of pre-warming the roasting apparatus or an operation of initialization of at least one filtering device.

3. A method according to claim 1, wherein the removable filtering device is cleanable, disposable or able the be regenerated.

4. A method according to claim 1, wherein the pressure of reference Pref is ambient pressure or a predetermined fixed pressure.

5. A method according to claim 1, wherein the at least one smoke treating unit comprises at least one upstream pressure sensor, said pressure sensor being configured to measure the pressure of the flow of smoke upstream said at least one removable filtering device, and wherein the pressure of reference Pref is the pressure measured at said upstream pressure sensor.

6. A method according to claim 1, wherein said method is applied in a system comprising:
several smoke treating units, each of said smoke treating units being configured to conduct and treat at least a part of the smoke through a dedicated path, and
an inlet ducting device to guide smoke emitted by the at least one roasting apparatus to at least one of the smoke treating units,
an outlet ducting device to guide smoke treated by the smoke treating units to an outlet of the system, and
wherein the at least one downstream pressure sensor is positioned to measure the pressure at said outlet ducting device.

7. A system for roasting coffee beans, said system comprising:
at least one roasting apparatus, said apparatus producing smoke during the heating of coffee beans, and
at least one smoke treating unit configured to treat at least a part of the flow of smoke produced by the at least one roasting apparatus, said smoke treating unit comprising at least one removable filtering device,
a smoke driver configured to drive smoke from the roasting apparatus to said at least one filtering device,
wherein the at least one smoke treating unit comprises at least one downstream pressure sensor, said downstream pressure sensor being configured to measure the pressure downstream said at least one removable filtering device, and
a control system.

8-9. (canceled)
